(19) United States
(12) Patent Application Publication
(10) Pub. No.: US 2017/0242562 A1
(43) Pub. Date: Aug. 24, 2017

(54) Remote Controller

(71) Applicant: Analogix Semiconductor, Inc., Santa Clara, CA (US)

(72) Inventors: André Bouwer, San Jose, CA (US); Kewei Yang, Saratoga, CA (US); Marvin Su, Palo Alto, CA (US); Soumendra Mohanty, San Jose, CA (US)

(21) Appl. No.: 15/430,074

(22) Filed: Feb. 10, 2017

Related U.S. Application Data
(60) Provisional application No. 62/297,611, filed on Feb. 19, 2016.

(51) Int. Cl. G06F 3/0485; G06F 3/0482; G06F 3/0488; G06F 3/0354

(52) U.S. Cl. CPC G06F 3/0485; G06F 3/03547; G06F 3/0482; G06F 3/04883

(57) ABSTRACT

A remote control unit for controlling a device is provided. An exemplary remote control unit includes a communications transceiver configured to communicate with the device and a touchpad for receiving input from a user while the remote control is communicatively coupled to the device. The touchpad may have one or more buttons, a first portion, and a second portion, each for receiving user inputs. The user inputs may be in the form of gestures. One gesture may include the moving of a digit of the user's hand vertically across the first portion. In response to receiving this particular gesture, the remote control is operable to initiate swiping a screen associated with a user interface of the device, scrolling a portion of the screen, or controlling various functionality of an application on the device. The device may be a mobile device, desktop computer device, or other audio/video computing device.

### CROSS-REFERENCE TO RELATED APPLICATIONS

The present application claims the benefit of U.S. Provisional Application No. 62/297,611, filed Feb. 19, 2016, which is incorporated herein by reference for all purposes.

The present application is also related to U.S. patent application Ser. No. 14/734,950, filed Jun. 9, 2015 (issued Jul. 12, 2016 as U.S. Pat. No. 9,389,698), which is a Continuation-In-Part of U.S. patent application Ser. No. 14/624,521, filed Feb. 17, 2015, which claims the benefit of U.S. Provisional Application No. 62/087,706, filed Dec. 4, 2014. The present application is also related to U.S. patent application Ser. No. 13/761,013, filed Feb. 6, 2013 (issued Jul. 14, 2015 as U.S. Pat. No. 9,084,106), and is also related to U.S. patent application Ser. No. 14/525,124, filed Oct. 27, 2014. The subject matter of the aforementioned applications is incorporated herein by reference for all purposes.

### FIELD

The present application relates to remote controls, and more specifically to a remote control unit for providing various functionality related to a computing device.

### BACKGROUND

Approaches described in this section should not be assumed to qualify as prior art merely by virtue of their inclusion therein.

Mobile devices are becoming increasingly popular due to their flexibility and ready access to rich content. A mobile device (which may be a mobile phone, a smart phone, a phablet, a tablet, a convertible notebook, an ultrathin notebook, and the like) can be coupled to a charging dock which can receive power (e.g., via a wall outlet) and provide it to the mobile device. For transmitting video data, the mobile device can be physically coupled to a video receiver. Tethering the mobile device thusly can constrain control of the mobile device by a user situated some distance away from the mobile device.

In addition, control of applications on non-mobile devices (which may be a desktop computer and other non-mobile computing devices) can be constrained when the non-mobile device is situated some distance away from a user. Moreover, certain functionalities provided in a typical desktop environment might not be provided when the device is situated some distance away from the user.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one embodiment of the disclosure, a remote control is provided for controlling a device. An exemplary remote control unit includes a communications transceiver configured to communicate with the device and a touchpad for receiving input from a user while the remote control unit is communicatively coupled to the device.

The touchpad may have one or more buttons, a first portion, and a second portion, each for receiving user inputs. The first portion of the touchpad may be configured for providing a touch scroll wheel functionality in response to a particular gesture, the particular gesture being moving a digit of a hand of theuser vertically across the first portion of the touchpad. In various embodiments, the touch scroll wheel functionality, provided by the first portion of the touchpad, is functionality provided by a trackpad, scroll wheel of a mouse, track ball, or the like. The second portion of the touchpad may comprise a switch actuated in response to depressing of the second portion by the user.

In some embodiments, the first portion of the remote control unit is located near an edge of a surface of the remote control unit and is located adjacent to the second portion of the remote control unit. The device may be a desktop device. In other embodiments, the device is a mobile device or other audio/video computing device.

According to various embodiments, in response to receiving this particular gesture, the remote control unit is operable to initiate an action, for example, swiping at least one screen associated with a user interface of the device, scrolling a portion of the at least one screen, or controlling functionality of an application on the device.

According to another example embodiment of the present disclosure, the steps of the method can be stored on a non-transitory machine-readable medium comprising instructions, which when implemented by one or more processors perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the drawings, in which like references indicate similar elements.

FIG. 1 is a block diagram of an example system for controlling a mobile device via a remote controller utilizing a docking station, according to an example embodiment.

FIG. 2 is a block diagram of an example docking station in the example system of FIG. 1.

FIG. 3 is a diagram illustrating elements of an example docking station in the example system of FIG. 1.

FIG. 4 is a block diagram of an example remote controller for the example system in FIG. 1.

FIG. 5A is a diagram showing an example shape of a remote controller for the example system in FIG. 1, according to an example embodiment.

FIG. 5B is another view of the remote controller of the example in FIG. 5A.

FIG. 6 is a flowchart showing steps of an example method for controlling a mobile device via a remote controller utilizing a charging dock in the example in FIG. 1.

FIG. 7 is a block diagram of another example system for controlling a device via a remote controller, where the charging dock is optional, according to another example embodiment.

FIG. 8 is a block diagram of another example remote controller for the example system in FIG. 7.

FIG. 9A is a block diagram showing an example shape of a remote controller in the example system in FIG. 7, according to another example embodiment.

FIG. 9B is another view of the remote controller of FIG. 9A in the example system in FIG. 7, according to another example embodiment.

FIG. 10 is a flowchart showing steps of a method for controlling a device via a remote controller, without utilizing a charging dock, according to another example embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In various embodiments, the technologies disclosed herein provide systems and methods for remote controlling devices via a remote controller. A remote (which may also be referred to as a remote control, a remote controller, a mobile device remote controller, and a smart phone remote controller) may enable a user to control the device.

In some embodiments, the methods and systems for remote controlling the device utilize an optional docking station (also referred to variously herein as a charging station, a charging dock, a charging tower, a docking tower, a dock tower, dock, a tower dock, tower section, and a tower). The optional docking station can facilitate video display provided by a mobile device to a display device, for example, a television set. The optional docking station may include a conversion processor and a remote controller for controlling the mobile device. The optional docking station can include a receptacle to receive the remote controller and may recharge the remote controller wirelessly or through transmission of power from electrical contacts of the receptacle to electrical contacts of the remote. The remote controller can communicate with the mobile device via Bluetooth, WiFi, or any other suitable communication protocol. In various embodiments, the remote control is locatable at, and removable from, the optional tower dock, and communicates with the mobile device.

The optional docking station that is included in some embodiments can provide media data comprising, for example, video and/or audio data, to a media player while the mobile device is plugged into the dock. The media player may be, for example, a high definition TV (HD TV) or ultra-high definition TV (UHD TV, including but not limited to 4K UHD (2160 p) and 8K UHD (4320 p)).

In some embodiments, a mobile device remote controller as described herein can be operable to extend the reach of a computing device, e.g., a smart phone. A smart phone remote controller may control applications running on the smart phone, such as navigating menus and/or controlling video stream playback on the smart phone and/or a media player (e.g., a television or monitor). The mobile device remote controller can be particularly useful when, for example, a mobile phone is not easily reachable, such as during charging and/or while being connected to a media player via a docking station. In some embodiments, the remote controller is connected to the smart phone through various wireless technology (e.g., WiFi, Bluetooth or any other suitable communication protocol), and may have very low power consumption, such that the remote controller does not require charging or battery replacement for many months. In further embodiments, the smart phone remote controller can be operable to receive incoming phone calls and/or place outgoing phone calls, and to issue voice commands to the operating system or an application on the mobile device.

According to some embodiments, a console unit may be provided that includes a remote control unit along with a tower section including a receptacle adapted for receiving the remote control unit at least partially therein. The remote control unit can include a communications transceiver configured to communicate with the mobile device. The tower section can further include a housing and at least one of: an interface, at least one media port, and a power port. The interface can be configured for coupling to the mobile device and for selectively receiving high definition media data and USB protocol data from the mobile device. The interface can be further configured for charging the mobile device. The at least one media port can be configured for providing the high definition media data to at least one media player device. The power port can be configured for coupling to a power source for receiving power.

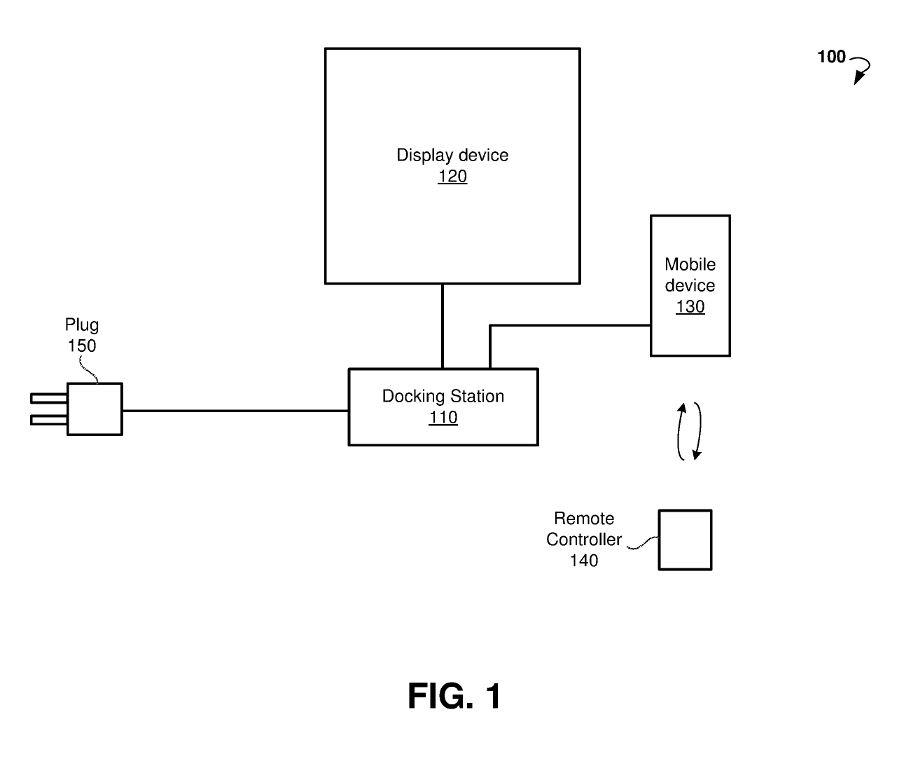

FIG. 1 is block diagram illustrating a system 100 for remote controlling a mobile device, according to certain embodiments of the present technology. In the example of FIG. 1, system 100 includes a mobile device 130 coupled to a docking station 110 via a cable. Mobile device 130 can be configured to receive power from docking station 110 for recharging the battery (or batteries) of mobile device 130.

In various embodiments, mobile device 130 provides media data to docking station 110 and can be controlled by remote controller 140. In some embodiments, the media data are provided by docking station 110 to a media player, for example, a display device 120. In various embodiments, docking station 110 is configured to receive power for converting data and for charging mobile device 130 via plug 150, which is insertable into a wall socket or other suitable power source (e.g., a power source in an automobile, a USB charging battery, and the like). The remote controller 140 can communicate wirelessly to control a mobile device 130 coupled to the docking station 110. In some embodiments, the remote controller 140 is operable to control any device using a Bluetooth mouse/trackpad HID (human interface device) protocol.

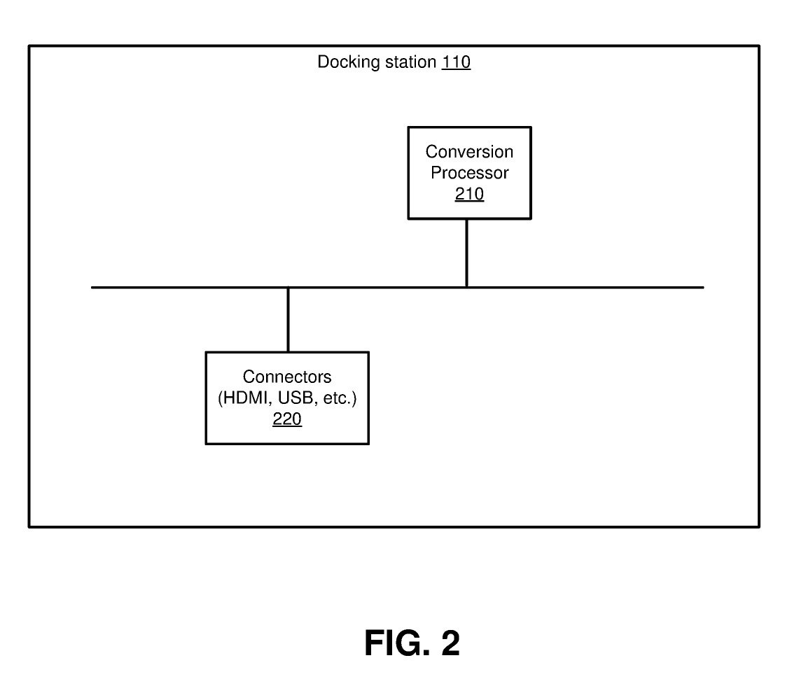

FIG. 2 is a block diagram showing components of a docking station 110 in the example system of FIG. 1, according to various example embodiments. The docking station 110 can include a conversion processor 210 and connectors 220.

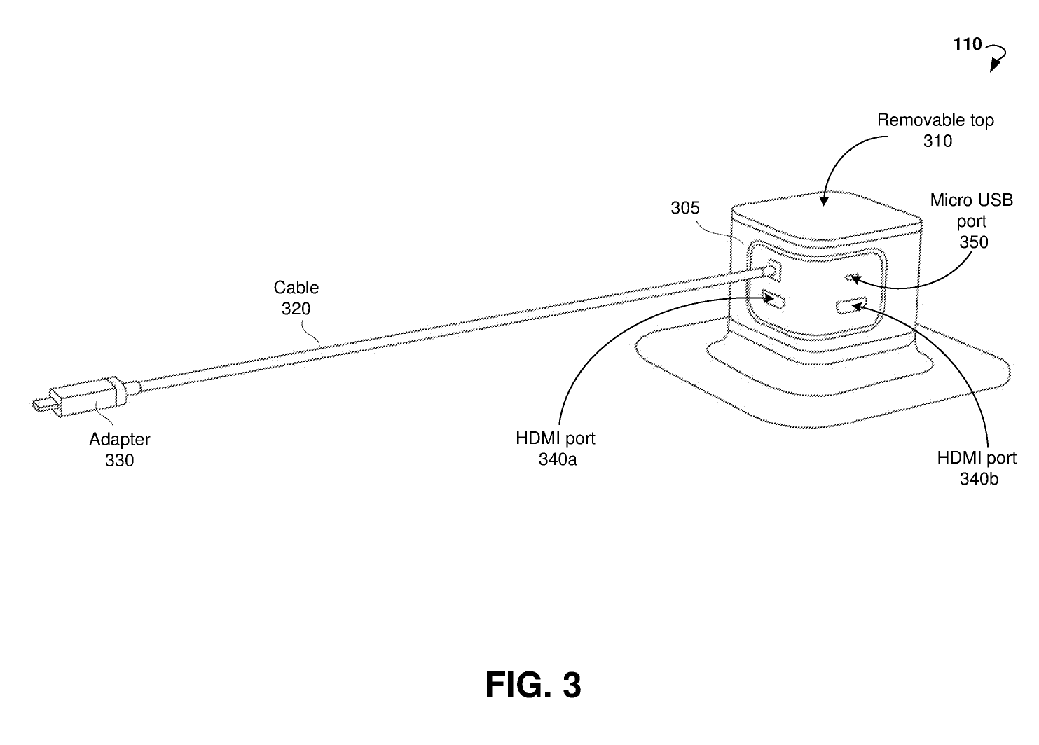

FIG. 3 is a block diagram showing an example docking station 110 example system of FIG. 1, according to various example embodiments. The example docking station 110 includes a housing 305, a removable top 310 (e.g., a removable remote control), a cable 320, an adapter 330, HDMI ports 340a and 340b, and a micro USB port 350. In various embodiments, the housing 305 of the docking station 110 includes a base and a recess on top of the base (for example, underneath the removable top 310), the recess being configured to receive the remote controller 140, e.g., when the remote controller 140 is not being held by a user. In various embodiments, the docking station 110 receives data (e.g., video data, audio data, or other appropriate media data or computer data) via a USB connector (or via any other appropriate device connector) from the mobile device 130 and provides the data to a media player, via an HDMI connector (or any other appropriate device connector, for example, a USB connector). It should be noted that the data as referred to herein may include video data only, both video and audio data, audio/video data being commonly referred to as just video data for short, or computer data typically communicated via USB.

In some embodiments, the conversion processor 210 in the docking station 110 is operable to be powered directly from a wall outlet. In certain embodiments, the docking station 110 includes multiple connectors (for example, two HDMI connectors, two USB connectors) for communicating variously with one or more display devices, or other devices (for example, a Chromecast player, and a Blu-Ray player).

Different connectors 220 are possible for different components of the docking station, as well as for different functionalities. In some embodiments, a DisplayPort connector or an HDMI connector, to name just a few, is used for video outputs from the docking station, and a micro-USB or other suitable USB connector may be used for video inputs to and/or video outputs from the docking station.

In some embodiments, multiple USB connections with the docking station can be made, for example, one to the mobile device 130 and one to the display device 120 or other media player, to name just a few.

The docking station 110 example system of FIG. 1 may operate using a DisplayPort standard and/or MyDP standard, as a digital audio-video interface as well as a USB 2.0 data interface connectivity between a transmitter (source) device and a receiver (sink) device using a standard 5-pin connector and a protocol. An enhanced protocol may be used, such enhanced protocol can be referred to as Slimport or Slimport Pro, both extensions of DisplayPort. In example embodiments, the transmitter (source) device is the mobile device (e.g., 130 in FIG. 1) coupled via cable 320 to the housing 305 of the docking station 110 (e.g., also referred to herein as a console unit when the remote controller 140 is included instead of, or in addition to, the removable top 310).

The cable 320 may include the adapter 330 configured for providing the operability of the protocol, e.g., the enhanced protocol. Further description of an exemplary cable is found in U.S. patent application Ser. No. 14/525,124, filed Oct. 27, 2014, which is incorporated by reference herein. In some embodiments, the enhanced protocol functionality provided by the adapter 330 and cable 320, may be provided instead within the dock station housing.

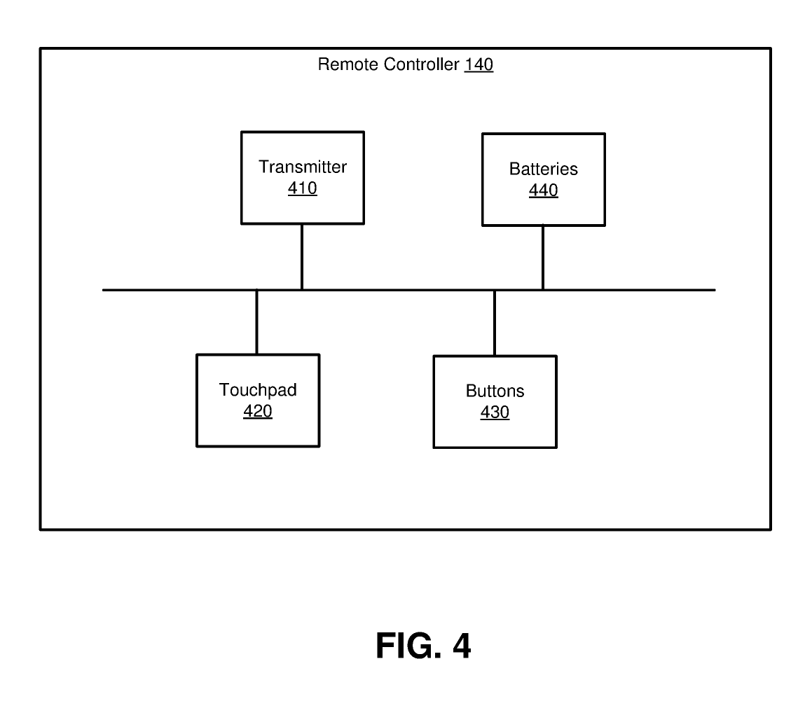

FIG. 4 is a block diagram showing the architecture of a remote controller 140 example system of FIG. 1 according to various example embodiments. The remote controller 140 can include a transmitter 410, a touchpad 420 (including various associated buttons), other buttons 430, and batteries 440. The transmitter 410 can be configured to communicate wirelessly with the mobile device 130 via Bluetooth (including Bluetooth Low Energy, (also known as Bluetooth Smart) and other Bluetooth protocols), WiFi, or any other suitable communication protocol.

In one example embodiment, the remote controller 140 is configured to allow a user to control a mobile device's user interface. The mobile device 130 may be connected to a docking station 110, such that, using the remote controller 140, the user can perform actions on the mobile device screen or the video displayed on a big screen by the mobile device 130 via docking station 110.

In some embodiments, various “buttons” on the remote controller 140 are accessible while the remote controller 140 is positioned on or in the receptacle (e.g., in the recess) at the top of the docking station 110. In particular, the remote controller 140 can be accessible by a user when the remote controller 140 is positioned, at least partially, on or in the receptacle of the docking station 110 and allows the user to access the touchpad 420 (including various associated buttons) and other buttons 430 in this position. The remote controller 140 can receive these inputs and controls of the mobile device 130 while being positioned, at least partially, on or in the receptacle of the docking station 110.

In various embodiments, the shape of the remote controller 140 is designed to blend into the shape of docking station 110 to create an integrated appearance when the remote controller 140 is disposed, at least partially, on or in the receptacle of the docking station 110. In some embodiments, the touchpad 420 (including various associated buttons) and other buttons 430 are operable to receive user input. An example arrangement of the buttons associated with the touchpad 420 can include three buttons associated with the Android operating system (Home, Back, and Recent Applications launcher). The user interface using the touchpad 420 may include various advantageous configurations.

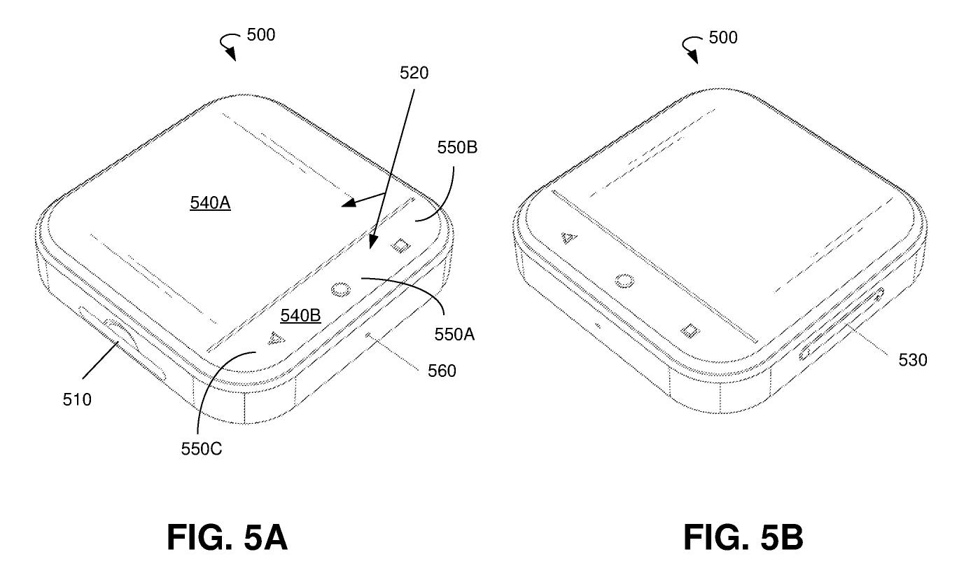

FIGS. 5A and 5B are diagrams illustrating example shapes and aspects of a remote control 500 according to various embodiments. Remote control 500 (also referred to variously herein as remote controller 500 and remote control unit 500) is an embodiment of remote controller 140 example system of FIG. 1. In some embodiments, the remote control 500 includes a touchpad 520. The touchpad 520 includes a first portion 540A (e.g., a trackpad portion) and a second portion 540B. The second portion 540B of the touchpad 520 provides for remote activation by a user of the primary Android buttons (Home, Back, and Recent Applications launcher) of the mobile device 130. In some embodiments, these primary Android buttons of the mobile device 130 are activated via three specific touch-sensitive areas 550A, 550B, and 550C located on the second portion 540B of the touchpad 520 as shown in FIG. 5A. The three touch-sensitive areas 550A, 550B, and 550C may correspond to the three primary Android buttons. (See exemplary button icons shown in FIGS. 5A and 5B). The user may activate each of the three buttons on the second portion 540B of the touchpad 520 by depressing a respective one of the touch-sensitive areas 550A, 550B, and 550C, so as to cause actuation of a micro-switch located underneath the surface of the second portion 540B of the touchpad 520 of the remote control 500.

In some embodiments, in order to perform an action on the mobile device 130 remotely, the user can first click on the first portion 540A of the touchpad 520, for instance, by depressing with a thumb the first portion 540A of the touchpad 520, so as to cause actuation of the micro-switch located underneath the surface of the first portion 540A of the touchpad 520. Thereafter, while the user's thumb is still on the first portion 540A of the touchpad 520 and the touchpad's “click” is still actuated, the user can move the thumb across the first portion 540A of the touchpad 520 to perform an action on the mobile device 130. After completing the action, the user may remove the thumb from the first portion 540A of the touchpad 520 to disengage the micro-switch.

In some embodiments, the action includes a “swipe” action for swiping to other screens of the mobile device's user interface, for example, for swiping screens, images, and user interface panels left, right, up, and down.

In some embodiments, by utilizing the remote control 500, the user of the mobile device 130 can perform a scrolling action to scroll a portion of user interface of the mobile device 130 in a situation when the scrolling functionality is available. The scrolling action can include scrolling up, down, left or right an information text, a webpage, an image, and so on.

In some embodiments, by utilizing the remote control 500, the user of the mobile device 130 can select and launch an application on the mobile device 130 and control the functionality of the application.

In some embodiments, by using the first portion 540A of the touchpad 520 and the touchpad's “click” (caused by depressing a micro-switch beneath the surface of the touchpad 520), a user of the mobile device 130 can type letters using a virtual keyboard in the mobile device's user interface, i.e., when the virtual keyboard is available.

In various embodiments, the remote control 500 is sized to be small enough to comfortably fit in a user's hand. For example, the remote control 500 can sit in the palm of the user's hand, allowing the user to perform actions and gestures on the touchpad 520 using the thumb of the same hand. In one example embodiment, the remote control 500 can be about a 45 mm square with a depth of about 10.5 mm. In another example embodiment, the remote control 500 can be about a 2.5 inches square with a depth of about ⅝ inches. In various embodiments, the remote control 500 is made of a soft-rubber material, or other materials with similar properties and texture. In other embodiments, the touchpad 520 is a smooth surface that facilitates performance of actions and gestures by the user. Other suitable sizes, shapes, and materials may be used in other embodiments of the remote control 500, with the remote control 500 comfortably-sized to fit in the palm of the user and the texture of the remote control 500 comfortable to the user while facilitating the use of the touchpad 520.

In an example embodiment, two coin batteries may be used with a battery tray 510 that slides out, optionally, in response to a pin or paper clip being inserted into an adjacent hole or in response to a finger causing the battery tray 510 to slide out, in order to provide battery power to the remote control 500. In various embodiments, the batteries are arranged within the remote control 500 to balance the weight distribution of the remote control 500 while in the user's hand, so as to facilitate performance of actions and gestures on the touchpad 520 or the rocker button 530 of the remote control 500. In some embodiments, the remote control 500 also includes an element 560, which may variously function to visually indicate (e.g., an LED light or the like that is actuated to indicate the remote control 500 is transmitting data) on the remote control 500 that a button press, gesture, etc., was performed by the user or that Bluetooth pairing mode is active, a low-power condition state, or the remote control 500 has been awaken from sleep mode, for example. The element 560 of remote control 500 may also provide for facilitating communicating data from the remote control 500. In other embodiments, the rocker button 530 can be used to control the shutter of a camera for taking a photograph on a mobile device 130.

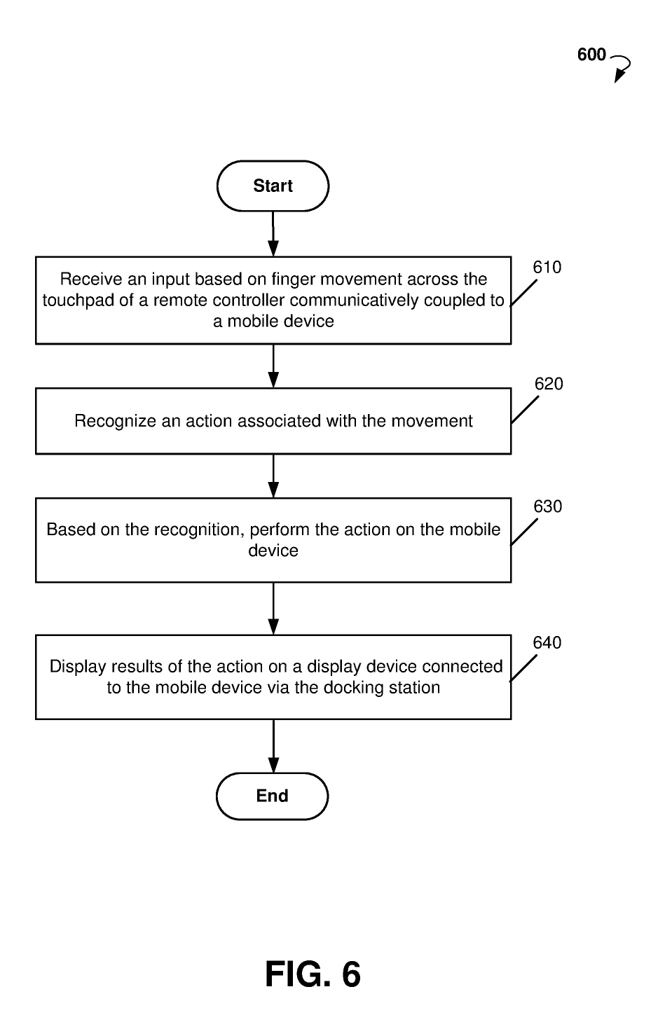

FIG. 6 is a flowchart showing steps of an example method 600 for remote controlling a mobile device in example system of FIG. 1. The method can be performed using remote controller 110, mobile device 130, docking station 110, and display device 120. In block 610, the method 600 receives an input as a user depresses the touchpad of a remote controller with a finger and while still depressing the touchpad (e.g., engaging a switch of the touchpad) moves the same finger across the touchpad. The remote controller can be communicatively coupled to a mobile device 130. The mobile device can be connected to the docking station. In block 620, method 600 proceeds to recognize an action associated with the movement. In block 630, method 600 proceeds to perform the action on the mobile device. In block 640, the method 600 displays results of the action on the display device. The display device can be connected to the mobile device via a docking station. The display device can be configured to display a screen of the mobile device.

In various embodiments, the remote controller may be used without the optional docking station and may provide functionality for controlling various mobile and non-mobile devices.

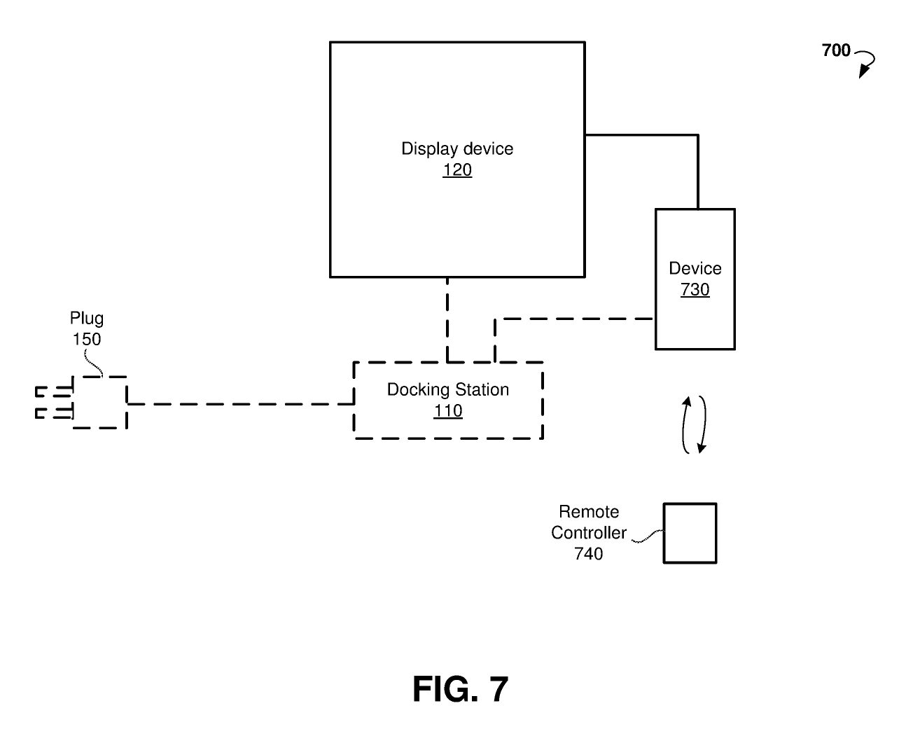

FIG. 7 is a block diagram of another example system 700 for controlling a device via a remote controller, where the charging dock is optional, according to various embodiments. In the example of FIG. 7, system 700 includes a device 730 which may be coupled to the display device 120 via a cable or wirelessly without the optional docking station 110. The device 730 may be a mobile device or non-mobile device (e.g., a non-mobile desktop computer device) or other audio/video computing device.

In various embodiments, an example system 700 includes remote controller 740, device 730, and display device 120, i.e., without the optional docking station 110 and plug 150.

Optionally, when the optional docking station 110 is used for the system 700, device 730 can be configured to receive power from the optional docking station 110 for recharging the battery (or batteries) of device 730. In the example where the optional docking station is utilized for device 730, description of operability with the optional docking station 110 is similar to that described above for the mobile device 130 in FIG. 1. For the system 700 in FIG. 7, the optional docking station 110 and aspects thereof may be as illustrated and described above with respect to FIGS. 2 and 3.

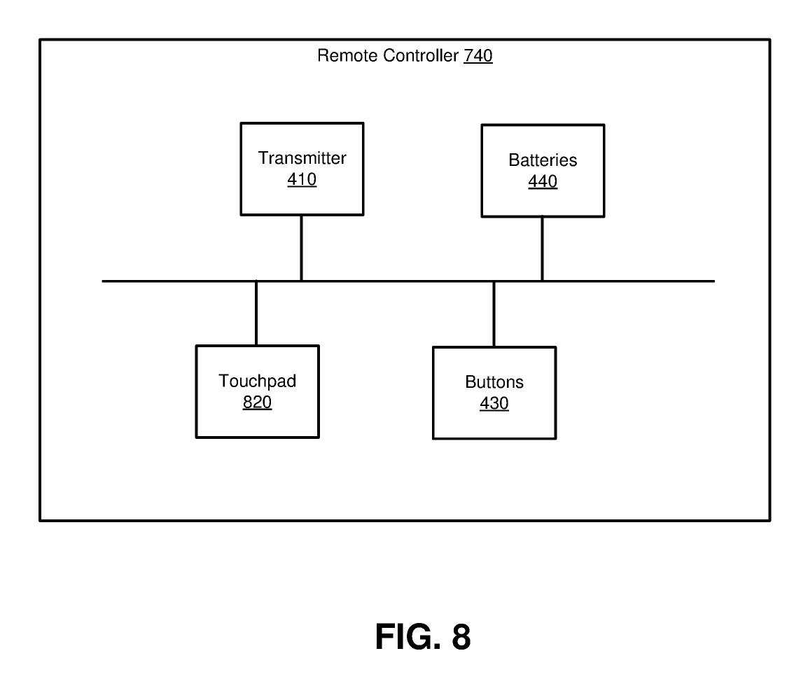

FIG. 8 is a block diagram of another example remote controller for the example system in FIG. 7, according to various example embodiments.

The remote controller 740 in FIG. 7 is an example embodiment of the remote controller 140 in the example in FIG. 4.

The remote controller 740 can include a transmitter 410, buttons 430, and batteries 440, as described above for the remote controller 140 in FIG. 4. The transmitter 410 can be configured to communicate wirelessly with the device 730 via Bluetooth (including Bluetooth Low Energy, (also known as Bluetooth Smart) and other Bluetooth protocols), WiFi, or any other suitable communication protocol.

In one example embodiment, the remote controller 740 is configured to allow a user to control a user interface of device 730, such that the user can perform an action on the device 730′s screen or the video (from device 730) as displayed on display device 120, which may provide a larger screen for viewing.

The remote controller 740 in the example in FIG. 8 includes a touchpad 820. The touchpad 820 is an embodiment of the touchpad 420 in FIG. 4.

In some embodiments, the touchpad 820 (including various associated buttons) and buttons 430 are operable to receive user input. An example arrangement of the buttons associated with the touchpad 820 can include three buttons associated with the Android operating system (Home, Back, and Recent Applications launcher).

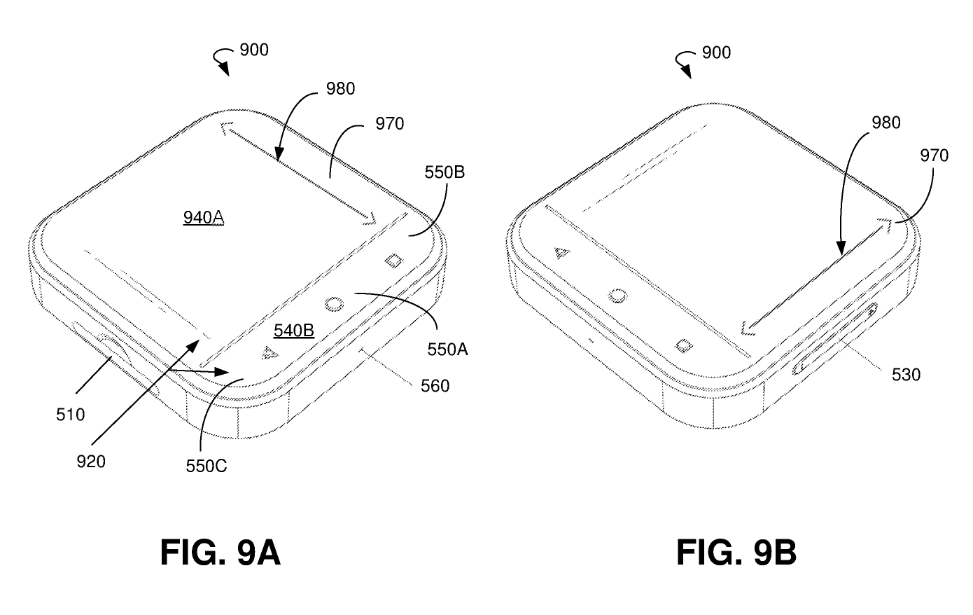

In addition to providing the functionality of the remote controller 140 described above, the remote controller 740 includes a touchpad 820 configured to provide a touch scroll wheel functionality. More specifically, in various embodiments, the touchpad 820 also provides the remote controller 740 with an area for receiving user input for a touch scroll wheel functionality. An example area is shown at 970 in FIGS. 9A and 9B. The remote controller 740 can provide touch scroll wheel functionality, for example, functionality provided by a scroll wheel of a mouse, track ball, trackpad, or other pointing device, for various device 730.

Referring to FIGS. 9A, and 9B, the remote controller 900 is an embodiment of the remote controller 740 in FIGS. 7 and 8. The example area shown at 970 may be a separate portion (e.g., 540B) at the edge of a face of the example remote controller 900, and may be adjacent to another, larger separate portion (e.g., 940A) of the remote controller 900.

In various embodiments, the touch scroll wheel functionality provided by remote controller 740 can be used for personal computer and laptop devices that support such functionality, including but not limited to personal computer and laptop devices utilizing Microsoft Windows 8, Windows 10, Mac OS X, and Android mobile devices, which support Bluetooth Smart (also known as Bluetooth Low Energy or BLE) capability provided by remote controller 740. (Other Bluetooth Smart aspects are described above with respect to the example in FIG. 4.)

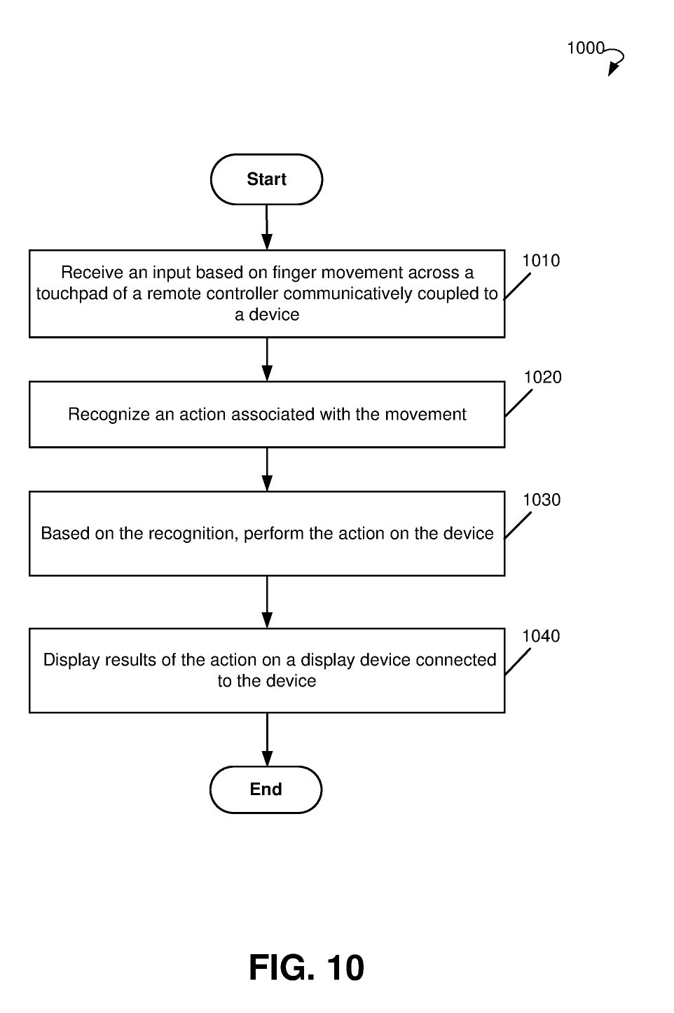

Further details regarding the touch scroll wheel functionality will be described below with reference to example embodiments shown in FIGS. 9A, 9B, and 10.

For use with the optional docking station 110, the remote controller 740 may be configured to utilize the optional docking station 110 in some embodiments. Various “buttons” on the remote controller 740 can be accessible while the remote controller 740 is positioned on or in the receptacle (e.g., in the recess) at the top of the optional docking station 110. In particular, the remote controller 740 can be accessible by a user when the remote controller 740 is positioned, at least partially, on or in the receptacle of the optional docking station 110 and allows the user to access the touchpad 820 (including various associated buttons) and other buttons 430 in this position. The remote controller 740 can receive these inputs and controls of the device 730 while being positioned, at least partially, on or in the receptacle of the docking station 110. In various embodiments, the shape of the remote controller 740 is designed to blend into the shape of docking station 110 to create an integrated appearance when the remote controller 740 is disposed, at least partially, on or in the receptacle of the docking station 110.

FIG. 9A is a block diagram showing an example shape of a remote controller, according to another example embodiment.

FIG. 9B is another view of the remote controller in FIG. 9A, according to another example embodiment.

Remote control 900 (also referred to variously herein as remote controller 900 and remote control unit 900) is an embodiment of remote controller 740 of the example system of FIG. 7. In some embodiments, the remote control 900 includes a touchpad 920. The touchpad 920 includes a first portion 940A (e.g., a trackpad portion) and a second portion 540B.

For some ones of device 730, the remote control 900 is configured to provide for a gesture that utilizes the touch scroll wheel functionality for performing certain scrolling actions. Remote control 900, in addition to providing the sizing, battery and other functionality provided by remote controller 140 described above, also includes a touchpad 920 configured to provide the touch scroll wheel functionality, which may be provided in addition to other touchpad functionalities described above. The touch scroll wheel functionality in this example would provide various scrolling functionality akin to that provided by a trackpad, scroll wheel of a mouse, track ball, or other pointing devices.

The first portion 940A includes an area 970 for user input for the touch scroll wheel functionality. The area 970 may be on the right side of the first portion 940A of the touchpad 920 as shown in FIGS. 9A and 9B. In other embodiments, the area for user input for the touch scroll wheel functionality is on the left side of the first portion 940A of the touchpad 920. The area 970 can provide an arrow arrangement, for example, the arrow arrangement 980 having two arrows joined by a line segment as shown in the examples in FIGS. 9A and 9B. In some embodiments, the arrow arrangement 980 may be moved slightly to the right/left or up/down from the placement shown in FIGS. 9A and 9B. In other embodiments, there is a line segment as shown in the examples in FIGS. 9A and 9B, without having the arrows.

As also described above, the touch scroll wheel functionality may be used for certain ones of device 730, such as a personal computer, laptop, phablet, tablet, wearable or other devices that support such functionality, including but not limited to devices utilizing Microsoft Windows 8, Windows 10, Mac OS X, and Android mobile devices, which support Bluetooth Smart (also known as Bluetooth Low Energy or BLE) capability provided by remote controller 740.

In some embodiments, the remote control 900 may enable certain mobile types of device 730 to provide full desktop-like user interface with display output on a larger display device and to provide full scrolling functionality akin to having a desktop with a mouse, a trackpad, or other pointing device on a larger display device.

The second portion 540B of the touchpad 920 provides for remote activation by a user of the primary Android buttons (Home, Back, and Recent Applications launcher) of the device 730. In some embodiments, these primary Android buttons of the device 730 are activated via three specific touch-sensitive areas 550A, 550B, and 550C located on the second portion 540B of the touchpad 920 as shown in FIG. 9A. The three touch-sensitive areas 550A, 550B, and 550C may correspond to the three primary Android buttons. (See exemplary button icons shown in FIGS. 9A and 9B). The user may activate each of the three buttons on the second portion 540B of the touchpad 920 by depressing a respective one of the touch-sensitive areas 550A, 550B, and 550C, so as to cause actuation of a micro-switch located underneath the surface of the second portion 540B of the touchpad 920 of the remote control 900.

For some ones of device 730, another gesture may be utilized for performing certain actions. More specifically, in some alternate embodiments, in order to perform certain actions on certain other ones of device 730 remotely, the user can first click on the first portion 940A of the touchpad 920, for instance, by depressing with a thumb the first portion 940A of the touchpad 920, so as to cause actuation of the micro-switch located underneath the surface of the first portion 940A of the touchpad 920. Thereafter, while the user's thumb is still on the first portion 940A of the touchpad 920 and the touchpad's “click” is still actuated, the user can move the thumb across the first portion 940A of the touchpad 920 to perform an action on certain ones of device 730. After completing the action, the user may remove the thumb from the first portion 940A of the touchpad 920 to disengage the micro-switch. In some embodiments, the action initiated by the depressing and moving includes a “swipe” action for swiping to other screens of the device's user interface, for example, for swiping screens, images, and user interface panels left, right, up, and down. In some embodiments and for certain ones of device 730, by utilizing the remote control 900, the user of the device 730 can utilize the depressing and perform a scrolling action to scroll a portion of a user interface of the device 730 in a situation when the scrolling functionality is available. The scrolling action can include the scrolling up, down, left or right of an information text, a webpage, an image, and so on. In some embodiments, by utilizing the remote control 900, the user of the device 730 can select and launch an application on the device 730 and control the functionality of the application.

In some embodiments, by using the first portion 940A of the touchpad 920 and the touchpad's “click” (caused by depressing a micro-switch beneath the surface of the touchpad 920), a user of the device 730 can type letters using a virtual keyboard in the device's user interface, i.e., when the virtual keyboard is available.

In various embodiments, the remote control 900 is sized to be small enough to comfortably fit in a user's hand. For example, the remote control 900 can sit in the palm of the user's hand, allowing the user to perform actions and gestures on the touchpad 920 using the thumb of the same hand. In one example embodiment, the remote control 900 can be about a 45 mm square with a depth of about 10.5 mm. In another example embodiment, the remote control 900 can be about a 2.5 inches square with a depth of about ⅝ inches. In various embodiments, the remote control 900 is made of a soft-rubber material, or other materials with similar properties and texture. In other embodiments, the touchpad 920 is a smooth surface that facilitates performance of actions and gestures by the user. Other suitable sizes, shapes, and materials may be used in other embodiments of the remote control 900, with the remote control 900 comfortably-sized to fit in the palm of the user and the texture of the remote control 900 comfortable to the user while facilitating the use of the touchpad 920.

In an example embodiment, two coin batteries may be used with a battery tray 510 that slides out, optionally, in response to a pin or paper clip being inserted into an adjacent hole or in response to a finger causing the battery tray 510 to slide out, in order to provide battery power to the remote control 900. In various embodiments, the batteries are arranged within the remote control 900 to balance the weight distribution of the remote control 900 while in the user's hand, so as to facilitate performance of actions and gestures on the touchpad 920 or the rocker button 530 of the remote control 900. In some embodiments, the remote control 900 also includes an element 560, which may variously function to visually indicate (e.g., an LED light or the like that is actuated to indicate the remote control 900 is transmitting data) on the remote control 900 that a button press, gesture, etc., was performed by the user or that Bluetooth pairing mode is active, a low-power condition state, or the remote control 900 has been awaken from sleep mode, for example. The element 560 of remote control 900 may also provide for facilitating communicating data from the remote control 900. In other embodiments, the rocker button 530 can be used to control the shutter of a camera for taking a photograph on a device 730.

FIG. 10 is a flowchart showing steps of a method 1000 for controlling a device 730 via a remote controller 740, according to another example embodiment.

The remote controller 740 may be utilized in the example system 700 in FIG. 7, with or without utilizing the optional charging dock, e.g., docking station 110.

The method 1000 can be performed using remote controller 740, device 730, and display device 120, e.g., as shown in the example in FIG. 7.

In block 1010, the method 1000 receives an input based on a finger movement across a touchpad 820 of a remote controller 740. The remote controller 740 can be communicatively coupled to a device 730, as described above. (In some embodiments, the device 730 and display device 120 are optionally connected to the docking station 110).

In block 1020, the method 1000 proceeds to recognize an action associated with the movement, for example, the movement of the user's finger with respect to a scroll wheel area 970 in FIGS. 9A and 9B.

In block 1030, the method 1000 proceeds to perform the action on the device.

In block 1040, the method 1000 displays results of the action on a display device. The display device 120 can be connected to the device 730 with or without use of a docking station 110. The display device 120 can be configured to display a screen of the device 730.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

What is claimed is:

1. A remote control unit for controlling a device, the remote control unit comprising:
a communications transceiver configured to communicate with the device; and
a touchpad for receiving input from a user while the remote control unit is communicatively coupled to the device, the touchpad having one or more buttons, a first portion, and a second portion, each of the one or more buttons, the first portion, and the second portion being for receiving input from the user;
the first portion of the touchpad is configured for providing a touch scroll wheel functionality in response to a particular gesture, the particular gesture being moving a digit of a hand of the user vertically across the first portion of the touchpad.

2. The remote control unit of claim 1, wherein the second portion of the touchpad comprises a switch actuated in response to depressing of the second portion by the user.

3. The remote control unit of claim 2, wherein the first portion of the remote control unit is located near an edge of a surface of the remote control unit and wherein the first portion of the remote control unit is located adjacent to the second portion of the remote control unit.

4. The remote control unit of claim 1, wherein the device is a desktop computer device.

5. The remote control unit of claim 1, wherein the device is a mobile device.

6. The remote control unit of claim 1, wherein the touch scroll wheel functionality is a functionality provided by a trackpad, scroll wheel of a mouse, or track ball.

7. The remote control unit of claim 1, further comprising, in response to receiving the particular gesture, the remote control unit is operable to initiate swiping a screen associated with a user interface of the device.

8. The remote control unit of claim 1, further comprising, in response to receiving the particular gesture, the remote control unit is operable to initiate scrolling of at least a portion of a screen associated with a user interface of the device.

9. The remote control unit of claim 8, wherein the scrolling includes scrolling an image, a text, or a webpage in an up, down, left, or right direction.

10. The remote control unit of claim 1, further comprising, in response to receiving the particular gesture, the remote control unit is operable to initiate controlling certain functionality of applications running on the device.

11. The remote control unit of claim 10, wherein the certain functionality of applications includes controlling video stream playback on the device.

12. The remote control unit of claim 10, wherein the certain functionality of applications includes navigating menus of the applications running on the device.

13. The remote control unit of claim 1, wherein the communications transceiver is configured to communicate wirelessly with the device via a Bluetooth Low Energy (BLE) protocol.

14. The remote control unit of claim 1, wherein the remote control unit has a size and shape which allows the remote control unit to fit in the user's hand.

15. The remote control unit of claim 14, wherein the remote control unit is about 45 mm square with a depth of about 10.5 mm.

16. A method for controlling a device using a remote control unit, the method comprising:
communicating, via a communications transceiver, with the device; and
receiving, via a touchpad on one surface of the remote control unit, a particular gesture from a user while the remote control unit is communicatively coupled to the device, the touchpad having one or more buttons, a first portion, and a second portion; each of the one or more buttons, the first portion, and the second portion being for receiving input from the user;
the first portion of the touchpad being for providing a touch scroll wheel functionality in response to the particular gesture, the particular gesture being moving a digit of a hand of the user vertically across the first portion of the touchpad; and
the second portion of the touchpad being located adjacent to the first portion of the touchpad, the second portion comprising a switch actuated in response to depressing of the second portion by the user.

17. The method of claim 16, wherein, in response to receiving the particular gesture, the remote control unit is operable to initiate swiping a screen associated with a user interface of the device.

18. The method of claim 16, wherein, in response to receiving the particular gesture, the remote control unit is operable to initiate scrolling of at least a portion of a screen associated with a user interface of the device.

19. The method of claim 16, wherein, in response to receiving the particular gesture, the remote control unit is operable to initiate controlling certain functionality of applications running on the device, wherein the certain functionality comprises at least navigating menus of the applications running on the device.

20. A non-transitory processor-readable medium having embodied thereon a program being executable by at least one processor to perform a method for controlling a mobile device using a remote control unit, the method comprising:
communicating, via a communications transceiver, with the mobile device; and
receiving, via a touchpad on one surface of the remote control unit, a particular gesture from a user while the remote control unit is communicatively coupled to the mobile device, the touchpad having one or more buttons, a first portion, and a second portion; each of the one or more buttons, the first portion, and the second portion being for receiving input from the user;
the first portion of the touchpad being for providing a touch scroll wheel functionality in response to the particular gesture, the particular gesture being moving a digit of a hand of the user vertically across the first portion of the touchpad; and
the second portion of the touchpad being located adjacent to the first portion of the touchpad, the second portion comprising a switch actuated in response to depressing of the second portion by the user.
